(19) United States
(12) Patent Application Publication
(10) Pub. No.: US 2016/0125047 A1
(43) Pub. Date: May 5, 2016

(54) Search Recommendation Method and Apparatus

(71) Applicant: BAIDU ONLINE NETWORK TECHNOLOGY (BEIJING) CO., LTD.), Beijing (CN)

(72) Inventors: Jizhou HUANG, Beijing (CN); Haifeng WANG, Beijing (CN); Minghua ZHAO, Beijing (CN); Duo ZHANG, Beijing (CN)

(21) Appl. No.: 14/898,532

(22) PCT Filed: Oct. 28, 2014
(86) PCT No.: PCT/CN2014/089735

§ 371 Date: Dec. 15, 2015

(30) Foreign Application Priority Data
Mar. 21, 2014 (CN) 201410109240.5

(51) Int. Cl. G06F 17/30

(52) U.S. Cl. CPC G06F 17/30554; G06F 17/30477

(57) ABSTRACT

Provided are a method and a device for search recommendations, said method comprising: reception of a search term; acquisition of a plurality of search results related to the search term, and acquisition from a knowledge bank of at least one content item related to the search term; acquisition of at least one recommended result on the basis of the search term and the at least one content item, and provision of a search page; the search page comprises a first display part and a second display part, a plurality of search results being displayed in the first display part, and at least one recommended result being displayed in the second display part. While providing users with search results, the method of the embodiments of the present invention also helps users get a grasp of comprehensive information related to the type of the search term used, thus providing more information relating to the intention of the search and satisfying user requirements while enhancing the user experience.

### FIELD

Embodiments of the present invention generally relate to a field of computer technology, and more particularly to a search recommendation method and a search recommendation apparatus.

### BACKGROUND

With the constant development of computer technology, the application of Internet becomes more and more popular, and the Internet users can obtain desired network resources via a search engine. Currently, the search engine may recommend some entity information related to a search term input by the user at a right side of a search page provided by the search engine to enable the user to obtain desired information conveniently, and may attach a picture to the entity information to provide the user with rich graphics-text information, so as to facilitate a comprehensive understanding of the entity information recommended by the search engine.

However, the problem is that the entity information recommended by the search engine fails to accord with the search intention and to satisfy the user requirement. For example, as shown in FIG. 1(a), if the user inputs a search term “Beijing” in the search engine, the search engine will recommend some cities and geographical names related to Beijing at the right side of the search page, or recommend some domestic cities with good air quality, but the user intends to acquire information of all aspects related to Beijing, such as scenic spots, culture, celebrities, food and landmarks, in which case the user experience of using the search engine is poor.

### SUMMARY

Embodiments of the present invention seek to solve at least one of the above technical problems.

Accordingly, a first objective of the present invention is to provide a search recommendation method which is able to provide the user with a search result and to help the user learn about general information related to the category of the search term, so as to offer the user information in line with the search intention, to satisfy the user requirement and improve the user experience.

A second objective of the present invention is to provide a search recommendation apparatus.

A third objective of the present invention is to provide a storage medium.

In order to achieve above objectives, embodiments of a first aspect of the present invention provide a search recommendation method. The method includes: receiving a search term; obtaining a plurality of search results related to the search term, and obtaining at least one content item related to the search term from a knowledge base; obtaining at least one recommendation result according to the search term and the at least one content item; and providing a search page, in which the search page includes a first display section and a second display section, the first display section displaying the plurality of search results, and the second display section displaying the at least one recommendation result.

The method according to embodiments of the present invention obtains the plurality of search results related to the search term according to the search term input by the user, obtains the content item related to the search term from the knowledge base, along with the corresponding recommendation result, and displays the search result, the content item and the recommendation result simultaneously in the search page to the user. Consequently, the method can help the user learn about general information related to the category of the search term at the same time of providing the user with the search result, so as to offer the user information in line with the search intention, to satisfy the user requirement and improve the user experience.

In order to achieve above objectives, embodiments of a second aspect of the present invention provide a search recommendation apparatus. The apparatus includes: a receiving module configured to receive a search term; a first obtaining module configured to obtain a plurality of search results related to the search term, and to obtain at least one content item related to the search term from a knowledge base; a second obtaining module configured to obtain at least one recommendation result according to the search term and the at least one content item; and a displaying module configured to provide a search page, in which the search page includes a first display section and a second display section, the first display section displaying the plurality of search results, and the second display section displaying the at least one recommendation result.

The apparatus according to embodiments of the present invention obtains the plurality of search results related to the search term according to the search term input by the user, obtains the content item related to the search term from the knowledge base, along with the corresponding recommendation result, and displays the search result, the content item and the recommendation result simultaneously in the search page to the user. Consequently, the apparatus can help the user learn about general information related to the category of the search term at the same time of providing the user with the search result, so as to offer the user information in line with the search intention, to satisfy the user requirement and improve the user experience.

In order to achieve above objectives, embodiments of a third aspect of the present invention provide a storage medium for storing an application program which is configured to execute the search recommendation method according to the embodiments of the present invention.

With the storage medium according to embodiments of the present invention, the plurality of search results related to the search term may be obtained according to the search term input by the user, the content item related to the search term may be obtained from the knowledge base, and the corresponding recommendation result may be obtained, and the search result, the content item and the recommendation result are displayed simultaneously in the search page to the user. Consequently, the storage medium can help the user learn about general information related to the category of the search term at the same time of providing the user with the search result, so as to offer the user information in line with the search intention, to satisfy the user requirement and improve the user experience.

Additional aspects and advantages of embodiments of the present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the drawings, in which:

FIGS. 1(a)-1(c) are schematic diagrams of entity information recommended by a search engine in the prior art;

FIG. 2 is a flow chart of a search recommendation method according to an embodiment of the present invention;

FIG. 3 is a schematic diagram of a content item and a corresponding recommendation result recommended by a search engine according to an embodiment of the present invention;

FIG. 4 is a schematic diagram of a content item and a corresponding recommendation result recommended by a search engine according to another embodiment of the present invention;

FIG. 5 is a block diagram of a search recommendation apparatus according to an embodiment of the present invention; and

FIG. 6 is a schematic diagram of a search page provided by a search engine according to another embodiment of the present invention.

### DETAILED DESCRIPTION

Embodiments described herein with reference to drawings are explanatory, illustrative, and used to generally understand the present invention. The embodiments shall not be construed to limit the present invention. In contrast, the embodiments of the present invention may include changes, modifications and equivalents within the spirit and scope of the appended claims.

In the description of the present invention, the term “a knowledge base” is a structured, operable, utilizable, comprehensive and organized knowledge cluster in knowledge engineering, and refers to a set of associated knowledge stored, organized, managed and used in a computer memory in a certain (or several) knowledge representation mode, regarding the requirement of solving a problem in a certain (or some) filed. The knowledge set includes theoretic knowledge, factual data, and heuristic knowledge acquired from expert experience in this field, for example, definitions, theorems, algorithms and common knowledge in a certain field. In the description of the present invention, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present invention includes other implementations, not necessarily in the sequence shown or discussed here, but probably including the almost same or reverse sequence of the involved functions, which should be understood by those skilled in the art.

A search recommendation method and a search recommendation apparatus according to embodiments of the present invention will be described in the following with reference to drawings.

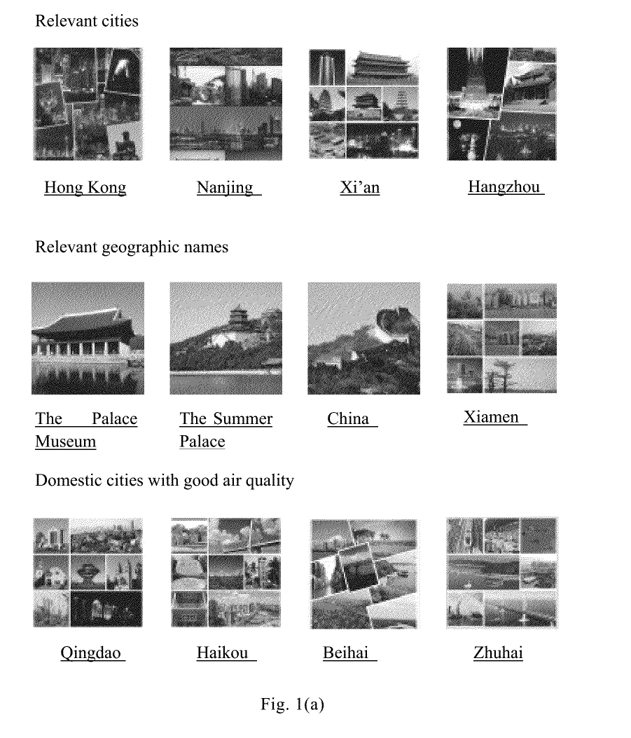

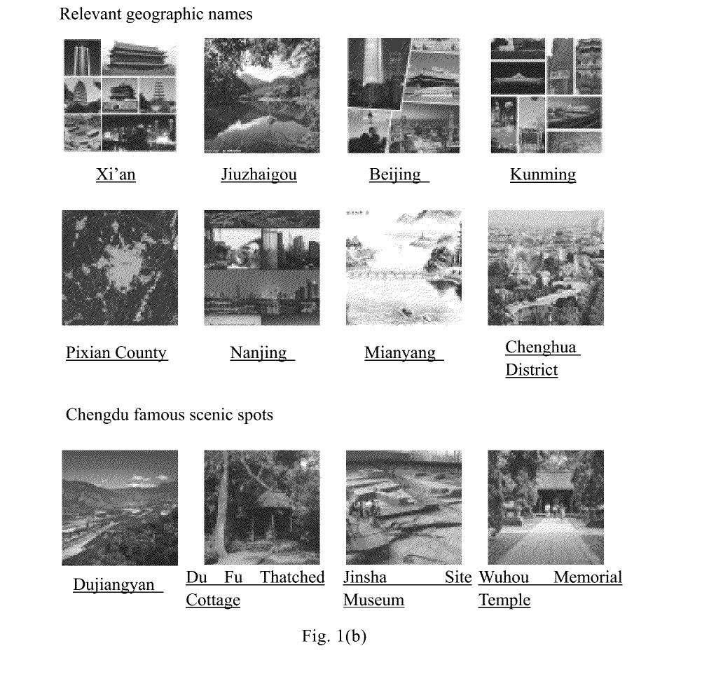

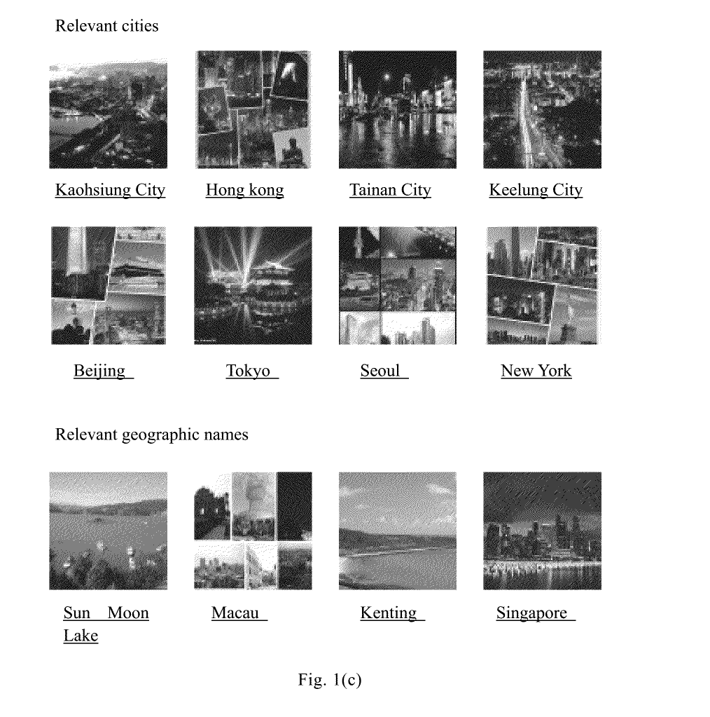

Currently, entity information recommended by a search engine often fails to accord with the search intention and to satisfy the user requirement. For example, as shown in FIG. 1(b), regarding a search term “Chengdu”, the search engine may recommend titles and graphic information of geographical names and famous scenic spots related to Chengdu in a right side of a search page. For another example, as shown in FIG. 1(c), regarding a search term “Taibei”, the search engine may recommend titles and graphic information of cities and geographical names related to Taibei in a right side of a search page.

If the search engine can recommend information of an appositive or subordinate entity related to the search term to the user according to the search term input by the user, it is beneficial for the user to understand general information related to the search term and a search result in accordance with the search intention may be provided to the user, which satisfies the user requirement and improves the user experience.

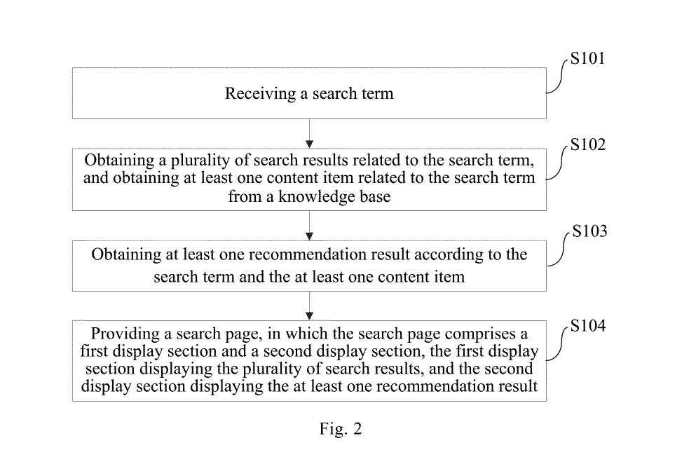

FIG. 2 is a flow chart of a search recommendation method according to an embodiment of the present invention. As shown in FIG. 2, the method includes the following steps.

In step 101, a search term is received.

Specifically, the user may input a search term in a search bar of a search page provided by a search engine. For instance, the user may input a geographic name (like “Beijing,” “Chengdu,” and “Taibei”), or input a person name (like “Yang Mi” and “Faye Wong”), or input a food name (like “ribs” and “steamed buns”).

In step 102, a plurality of search results related to the search term are obtained, and at least one content item related to the search term is obtained from a knowledge base.

Specifically, the search engine may obtain information related to the search term from the Internet according to the search term via a search strategy of the search engine, and obtain a plurality of search results related to the search term after organizing and processing the information. Different from the current search engine, the search engine in the embodiment of the present invention may obtain one or more appositive or subordinate content items of the search term from the knowledge base at the same time of obtaining the plurality of search results. The content item may be a content item preset by the search engine and be related to the category of the search term. The search engine may find out a corresponding content item from the knowledge base according to the search term, and may further obtain the content item corresponding to the search term according to a search history log and/or a click history log of the user.

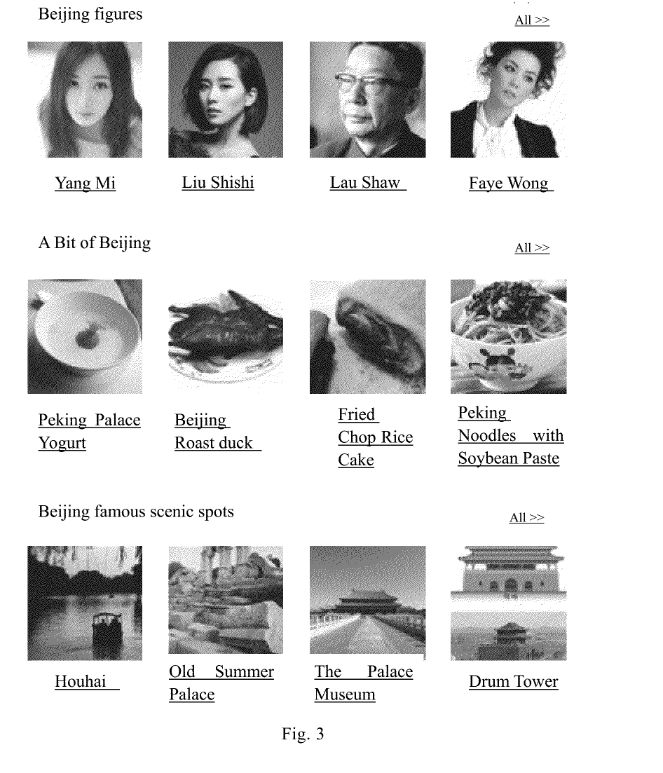

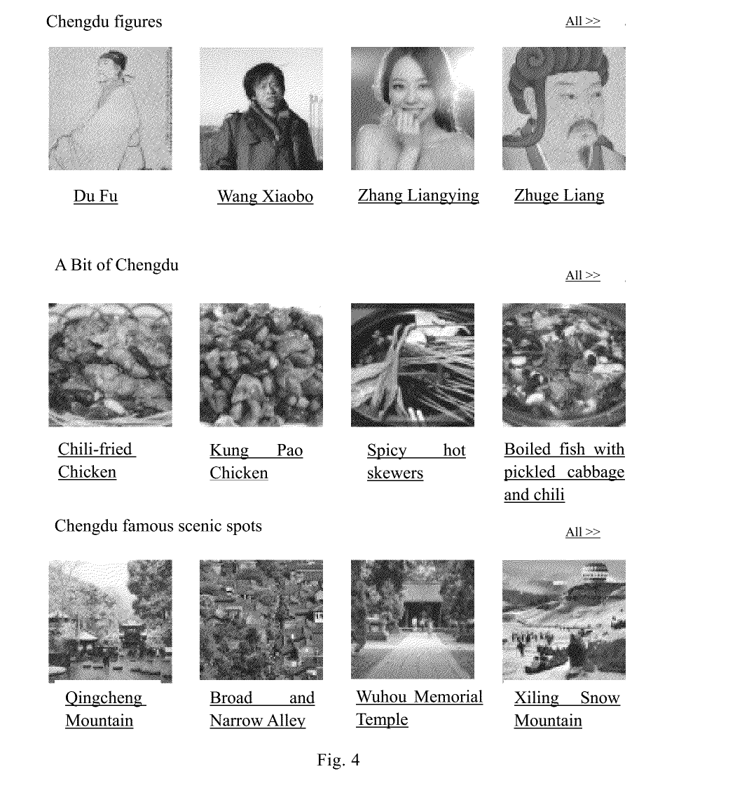

For example, as shown in FIG. 3, if the search term input by the user is “Beijing”, the search engine may obtain a plurality of subordinate content items of the search term, such as “Beijing figures,” “a bit of Beijing,” and “Beijing famous scenic spots”. For another example, as shown in FIG. 4, if the search term input by the user is “Chengdu”, the search engine may obtain a plurality of subordinate content items of the search term, such as “Chengdu figures,” “a bit of Chengdu,” and “Chengdu famous scenic spots”. That is, the search engine not only obtains the search result related to the search term, but also obtains some content items of relevant entities according to the category of the search term, such as celebrities, scenic spots, delicious food, culture and landmarks.

In step 103, at least one recommendation result is obtained according to the search term and the at least one content item.

Specifically, after obtaining the plurality of search results related to the search term and the plurality of content items corresponding to the search term, the search engine may obtain a plurality of recommendation results corresponding to each content item from the Internet via the search strategy of the search engine. The recommendation result includes a picture and relevant explanations.

For example, as shown in FIG. 3, if the content item is “Beijing figures”, the search engine may obtain pictures and names of corresponding celebrities, like “Yang Mi,” “Liu Shishi,” “Lau Shaw,” etc.; if the content item is “a bit of Beijing”, the search engine may obtain pictures and names of corresponding food, like “Peking Palace Yogurt,” “Beijing Roast Duck,” “Peking Noodles with Soybean Paste,” etc.; if the content item is “Beijing famous scenic spots”, the search engine may obtain pictures and names of corresponding scenic spots, like “Houhai,” “Old Summer Palace,” “the Palace Museum,” etc. For another example, as shown in FIG. 4, if the content item is “Chengdu figures”, the search engine may obtain pictures and names of corresponding celebrities, like “Du Fu,” “Zhang Liangying,” “Zhuge Liang,” etc.; if the content item is “a bit of Chengdu”, the search engine may obtain pictures and names of corresponding food, like “chili-fried chicken,” “kung pao chicken,” “boiled fish with pickled cabbage and chili,” etc.; if the content item is “Chengdu famous scenic spots”, the search engine may obtain pictures and names of corresponding scenic spots, like “Qingcheng Mountain,” “Wuhou Memorial Temple,” “Xiling Snow Mountain,” etc.

It shall be understood that the search engine may overlay the picture with the relevant explanations of the picture at a corresponding position according to a preset algorithm, and display the picture and the relevant explanations thereon as a whole.

In step 104, a search page is provided, in which the search page includes a first display section and a second display section, the first display section displaying the plurality of search results, and the second display section displaying the at least one recommendation result.

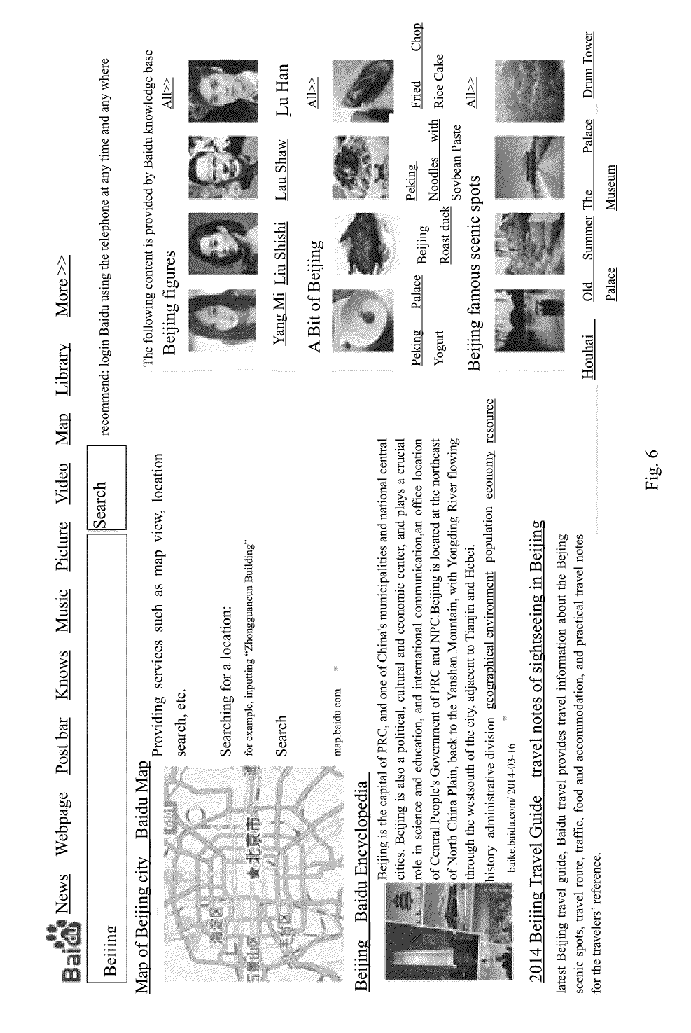

In the embodiment of the present invention, the first display section is located at a left side of the search page, and the second display section is located at a right side of the search page. Specifically, as shown in FIG. 6, the search engine may display the plurality of search results related to the search term and the plurality of recommendation results corresponding to each content item respectively in the search page provided by the search engine after obtaining the plurality of recommendation results corresponding to each content item. The search engine may divide the search page into two sections, i.e. the first display section and the second display section, in which the plurality of search results related to the search term are displayed in the first display section at the left side of the search page, and the plurality of recommendation results corresponding to each content item are displayed in the second display section at the right side of the search page.

It shall be understood that as shown in FIGS. 3 and 4, the search engine may display some of the plurality of content items and corresponding recommendation results, and hide the rest content items and recommendation results, and add a virtual button at the upper right corner of the search page to unfold the entire content items and recommendation results. If the user clicks the button “All”, all the recommendation results of the content items (such as “Beijing figures” or “Chengdu famous scenic spots”) in the knowledge base may be unfolded to form a special list page for search.

The method according to embodiments of the present invention obtains the plurality of search results related to the search term according to the search term input by the user, obtains the content item related to the search term from the knowledge base, along with the corresponding recommendation result, and displays the search result, the content item and the recommendation result simultaneously in the search page to the user. Consequently, the method can help the user learn about general information related to the category of the search term at the same time of providing the user with the search result, so as to offer the user information in line with the search intention, to satisfy the user requirement and improve the user experience.

To realize the above embodiments, the present invention further provides a search recommendation apparatus.

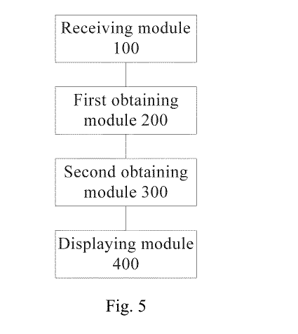

FIG. 5 is a block diagram of a search recommendation apparatus according to an embodiment of the present invention. As shown in FIG. 5, the apparatus includes: a receiving module 100, a first obtaining module 200, a second obtaining module 300 and a displaying module 400.

The receiving module 100 is configured to receive a search term. Specifically, the user may input a search term in a search bar of a search page provided by a search engine to the receiving module 100. For instance, the user may input a geographic name (like “Beijing,” “Chengdu,” and “Taipei”), or input a person name (like “Yang Mi” and “Faye Wong”), or input a food name (like “ribs” and “steamed buns”).

The first obtaining module 200 is configured to obtain a plurality of search results related to the search term and to obtain at least one content item related to the search term from a knowledge base. Specifically, the first obtaining module 200 may obtain information related to the search term from the Internet according to the search term via a search strategy of the search engine, and obtain a plurality of search results related to the search term after organizing and processing the information. Different from the current search engine, the first obtaining module 200 in the embodiment of the present invention may obtain one or more appositive or subordinate content items of the search term at the same time of obtaining the plurality of search results. The knowledge base is a structured, operable, utilizable, comprehensive and organized knowledge cluster in knowledge engineering, and refers to a set of associated knowledge stored, organized, managed and used in a computer memory in a certain (or several) knowledge representation mode, regarding the requirement of solving a problem in a certain (or some) filed. The knowledge set includes theoretic knowledge, factual data, and heuristic knowledge acquired from expert experience in this field, for example, definitions, theorems, algorithms and common knowledge in a certain field. The content item may be a content item preset by the search engine and be related to the category of the search term. The first obtaining module 200 may find out a corresponding content item from the knowledge base according to the search term, and may further obtain the content item corresponding to the search term according to a search history log and/or a click history log of the user.

For example, as shown in FIG. 3, if the search term input by the user is “Beijing”, the first obtaining module 200 may obtain a plurality of subordinate content items of the search term, such as “Beijing figures,” “a bit of Beijing,” and “Beijing famous scenic spots”. For another example, as shown in FIG. 4, if the search term input by the user is “Chengdu”, the first obtaining module 200 may obtain a plurality of subordinate content items of the search term, such as “Chengdu figures,” “a bit of Chengdu,” and “Chengdu famous scenic spots”. That is, the first obtaining module 200 not only obtains the search result related to the search term, but also obtains some content items of relevant entities according to the category of the search term, such as celebrities, scenic spots, delicious food, culture and landmarks.

The second obtaining module 300 is configured to obtain at least one recommendation result according to the search term and the at least one content item. Specifically, after the first obtaining module 200 obtains the plurality of search results related to the search term and the plurality of content items corresponding to the search term, the second obtaining module 300 may obtain a plurality of recommendation results corresponding to each content item from the Internet via the search strategy. The recommendation result includes a picture and relevant explanations.

For example, as shown in FIG. 3, if the content item is “Beijing figures”, the second obtaining module 300 may obtain pictures and names of corresponding celebrities, like “Yang Mi,” “Liu Shishi,” “Lau Shaw,” etc.; if the content item is “a bit of Beijing”, the second obtaining module 300 may obtain pictures and names of corresponding food, like “Peking Palace Yogurt,” “Beijing Roast Duck,” “Peking Noodles with Soybean Paste,” etc.; if the content item is “Beijing famous scenic spots”, the second obtaining module 300 may obtain pictures and names of corresponding scenic spots, like “Houhai,” “Old Summer Palace,” “the Palace Museum,” etc. For another example, as shown in FIG. 4, if the content item is “Chengdu figures”, the second obtaining module 300 may obtain pictures and names of corresponding celebrities, like “Du Fu,” “Zhang Liangying,” “Zhuge Liang,” etc.; if the content item is “a bit of Chengdu”, the second obtaining module 300 may obtain pictures and names of corresponding food, like “chili-fried chicken,” “kung pao chicken,” “boiled fish with pickled cabbage and chili,” etc.; if the content item is “Chengdu famous scenic spots”, the second obtaining module 300 may obtain pictures and names of corresponding scenic spots, like “Qingcheng Mountain,” “Wuhou Memorial Temple,” “Xiling Snow Mountain,” etc.

The displaying module 400 is configured to provide a search page, in which the search page includes a first display section and a second display section. The first display section is located at a left side of the search page, and the second display section is located at a right side of the search page; the first display section displays the plurality of search results, and the second display section displays the at least one recommendation result. Specifically, as shown in FIG. 6, the displaying module 400 may display the plurality of search results related to the search term and the plurality of recommendation results corresponding to each content item respectively in the search page provided by the search engine to the user after the second obtaining module 300 obtains the plurality of recommendation results corresponding to each content item. The displaying module 400 may divide the search page into two sections, i.e. the first display section and the second display section, in which the plurality of search results related to the search term are displayed in the first display section at the left side of the search page, and the plurality of recommendation results corresponding to each content item are displayed in the second display section at the right side of the search page.

The apparatus according to embodiments of the present invention obtains the plurality of search results related to the search term according to the search term input by the user, obtains the content item related to the search term from the knowledge base and obtains the corresponding recommendation result, and displays the search result, the content item and the recommendation result simultaneously in the search page to the user. Consequently, the apparatus can help the user learn about general information related to the category of the search term at the same time of providing the user with the search result, so as to offer the user information in line with the search intention, to satisfy the user requirement and improve the user experience.

To realize the above embodiments, the present invention further provides a storage medium for storing an application program which is configured to execute the search recommendation method according to any embodiment of the present invention.

With the storage medium according to embodiments of the present invention, the plurality of search results related to the search term may be obtained according to the search term input by the user, the content item related to the search term may be obtained from the knowledge base, also the corresponding recommendation result may be obtained, and the search result, the content item and the recommendation result are displayed simultaneously in the search page to the user. Consequently, the storage medium can help the user learn about general information related to the category of the search term at the same time of providing the user with the search result, so as to offer the user information in line with the search intention, to satisfy the user requirement and improve the user experience.

It should be understood that each part of the present invention may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present invention. Thus, the appearances of the above phrases in various places throughout this specification are not necessarily referring to the same embodiment or example of the present invention. Furthermore, the particular features or characteristics may be combined in any suitable manner in one or more embodiments or examples. Moreover, different embodiments or examples, and the features in different embodiments or examples of the present invention may be integrated and combined.

Although the embodiments of the present invention have been shown and described, it would be appreciated by those skilled in the art that the above embodiments are explanatory and cannot be construed to limit the present invention, and changes, modifications, alternatives and variations can be made in the embodiments without departing from spirit, principles and scope of the present invention.

What is claimed is:

1. A search recommendation method, comprising:
receiving a search term;
obtaining a plurality of search results related to the search term, and obtaining at least one content item related to the search term from a knowledge base;
obtaining at least one recommendation result according to the search term and the at least one content item; and
providing a search page, wherein the search page comprises a first display section and a second display section, the first display section displaying the plurality of search results, and the second display section displaying the at least one recommendation result.

2. The method according to claim 1, wherein the first display section is located at a left side of the search page, and the second display section is located at a right side of the search page.

3. The method according to claim 1 or 2, wherein the at least one content item is a preset content item and is related to a category of the search term.

4. The method according to any one of claims 1 to 3, wherein the at least one content item is obtained according to the search term and according to a search history log and/or a click history log of a user.

5. The method according to any one of claims 1 to 4, wherein the recommendation result comprises a picture and an explanation about the picture.

6. A search recommendation apparatus, comprising:
a receiving module configured to receive a search term;
a first obtaining module configured to obtain a plurality of search results related to the search term, and to obtain at least one content item related to the search term from a knowledge base;
a second obtaining module configured to obtain at least one recommendation result according to the search term and the at least one content item; and
a displaying module configured to provide a search page, wherein the search page comprises a first display section and a second display section, the first display section displaying the plurality of search results, and the second display section displaying the at least one recommendation result.

7. The apparatus according to claim 6, wherein the first display section is located at a left side of the search page, and the second display section is located at a right side of the search page.

8. The apparatus according to claim 6 or 7, wherein the at least one content item is a preset content item and is related to a category of the search term.

9. The apparatus according to any one of claims 6 to 8, wherein the at least one content item is obtained according to the search term and according to a search history log and/or a click history log of a user.

10. The apparatus according to any one of claims 6 to 9, wherein the recommendation result comprises a picture and an explanation about the picture.

11. A storage medium for storing an application program which is configured to execute the search recommendation method according to any one of claims 1 to 5.
